(19) United States
(12) Patent Application Publication
(10) Pub. No.: US 2024/0178550 A1
(43) Pub. Date: May 30, 2024

(54) COMMUNICATION MODULES AND STREET LIGHTS INCORPORATING SUCH MODULES

(71) Applicant: SIGNIFY HOLDING B.V., EINDHOVEN (NL)

(72) Inventors: MATTHIAS WENDT, Würselen (DE); BARTEL MARINUS VAN DE SLUIS, EINDHOVEN (NL); MAURICE HERMAN JOHAN DRAAIJER, ITTERVOORT (NL)

(21) Appl. No.: 18/284,980

(22) PCT Filed: Apr. 5, 2022
(86) PCT No.: PCT/EP2022/058971

§ 371 Date: Sep. 29, 2023

(30) Foreign Application Priority Data
Apr. 8, 2021 (EP) 21167404.9

(51) Int. Cl. H01Q 1/24; F21S 8/08; H01Q 21/06

(52) U.S. Cl. CPC H01Q 1/246; H01Q 21/06; F21S 8/086

(57) ABSTRACT

A communications module comprises a sleeve for extending around a portion of a street light. An antenna circuit is integrated into the sleeve and comprises an array of antennas for implementing communication with user mobile devices in the vicinity of the street light.

### FIELD OF THE INVENTION

The invention relates to communications systems, for communicating with multiple users in a shared space.

### BACKGROUND OF THE INVENTION

Cellular mobile telephony is currently the most widespread system for allowing multiple system users to communicate with each other. Such systems use an antenna mast to define a cell, wherein all users within the cell communicate via the antenna mast.

A more recent development is the so-called massive multiple input multiple output, mMIMO, data communication system.

Massive MIMO technology is set to be a core component of super-fast 5G networks. It allows the transmitting and receiving of more than one data signal simultaneously over the same radio channel. Massive MIMO system make use of a large number, typically tens or hundreds, of transmit and receive antennas distributed with an area.

The advantage of a MIMO network is that it can multiply the capacity of a wireless connection without requiring more spectrum. The more antennas the transmitter/receiver is equipped with, the more the possible signal paths and the better the performance in terms of data rate and link reliability. Massive MIMO system also enable the computing power to be distributed.

Massive MIMO networks use beamforming technology, enabling the targeted use of spectrum. Current mobile networks allocate a single pool of spectrum between all users in the vicinity, which results in a performance bottleneck in densely populated area. With massive MIMO and beamforming, such a process is handled far more smartly and efficiently, so that data speeds and latency can be made far more uniform across the network.

One requirement for a massive MIMO system is to have a large number of antennas distributed at more proximal locations than typical cellular antenna masts. At each location, there may be tens or hundreds of individual antennas.

An antenna design, called a “radio stripe” is for example described in WO 2018/103897. The radio stripe is formed as a foil which carries a metallization for antennas as well as a data connection bus. Antenna processing units (APUs) are mounted along the bus as a naked chip or flip-chip connection to the bus. Each APU can drive multiple antennas and consists of a digital signal processor DSP, I/Q modulators/demodulators and RF amplifiers. The DSP of each APU connects to a RF backend processing unit via the bus.

Each backend processing unit can control a number of independent chains of APUs. Power for the APUs is also distributed over the printed bus structure.

US 2019/226672 A1 discloses a lighting fixture including a pole having a first section and a second section. The second section of the pole includes a radio frequency (RF) transparent material. The lighting fixture also includes a light housing coupled to the first section of the pole and a light source in the light housing. The lighting fixture further includes an antenna assembly in the second section of the pole. The antenna assembly is configured to wirelessly communicate with a user equipment device (UE). The lighting fixture also includes a communications backhaul interface coupled to the antenna assembly.

The installation of antenna systems at a large number of sites presents difficulties and cost to the installation of such a system. The required number of access points is dependent on the density of expected connections. Due to the high density of mobile communication as required in cities, there will need to be a large number of antenna installations.

### SUMMARY OF THE INVENTION

The invention is defined by the claims.

According to examples in accordance with an aspect of the invention, there is provided a communications module comprising:
a sleeve for extending around a portion of a street light;
an antenna circuit integrated into the sleeve comprising an array of antennas; and
communications circuitry integrated into the sleeve and electrically connected to the antennas,
wherein the communications circuitry comprises a respective antenna processing circuit for each of the antennas, for implementing communication with user mobile devices in the vicinity of the street light.

This module may be attached to (or formed as part of) a portion of a street light, e.g., a lamp post or a housing of street light luminaire, for example. This enables the existing street light infrastructure to be used to form access points of a network for communicating with user mobile devices, i.e. a communications system for communicating between the mobile devices, typically cellular mobile phones or tablets, of users. The communications circuitry is for example implemented with a large number of antennas each with an associated antenna processing circuit. The overall communications system for example has more antennas than active users.

The antenna processing circuit for example comprises packet switching circuitry, modulation and demodulation circuitry and amplification circuitry.

The communications circuitry may comprises antenna processing circuits for a cell-free massive multiple input multiple output, mMIMO, communications system.

The antennas thus preferably form part of a cell-free massive MIMO system, in which a large number of low cost distributed antennas connect to a network controller, and each antenna functions as a separate access point. Different antennas within the communications module have a different directionality so that in combination they define a service area of the network. The cell-free massive MIMO system is a distributed MIMO system. The main properties of cell-free mMIMO, also referred to as CF mMIMO, are that there are many geographically distributed access points APs, but the coverage area is not divided into disjoint cells. A “cell” refers to the geographic area that is covered by a single base station (e.g. incorporated in an antenna mast) in a cellular mobile communication network. Such networks comprise a large number of base stations to efficiently use radio spectrum to cover a service area. In CF mMIMO each user equipment UE, such as a cell phone, a wirelessly-equipped personal computer or tablet, a tracking device, a wireless sensor or other device equipped with wireless communication functionality (whether or not operated by a human user), is served by all the surrounding access points and not by a single base station.

The portion of a street light for example comprises a street light support structure or a street light luminaire.

The support structure may be an upright post (i.e. a lamp post) or a horizontal support arm between a lamp post and a luminaire (i.e. a street lamp head). Within a system, there may be communications modules on both vertical and horizontal supports.

The antennas of the array may be spaced around the sleeve thereby to be spaced around the street light portion.

Different antennas thereby have a different directional input/output extending to/from the support structure.

In one set of examples, the communications module comprises an independent unit for fitting around the street light portion. This enables retrofitting to existing street lamps.

The sleeve may comprise first and second sleeve halves which are fixable around the street light portion in as unobtrusive manner as possible, hence without attracting attention and allowing for easy cleaning of the street light portion.

This provides a simple way to retrofit the module to an existing support structure. The first and second sleeve halves may be hinged together or strapped together.

The communications module may comprise a spring bias arrangement to enable the sleeve to fit to a range of sizes of street light portion. Alternatively, the sleeve may be flexible and is for gluing to the street light portion.

These options enable a single design to be suitable for retrofitting to a variety of different support structures.

The communications module may comprise an adjustable spacing element for adjusting a spacing between the antenna and the street light portion. This adjustment may be used to optimize the radiation performance. For example, if the street light support structure is functioning as the ground plane, the distance to ground can be adjusted.

In another set of examples, the sleeve is an integral part of the street light portion. Thus, for new installations, a sleeve may be designed into the support structure or the luminaire.

The antenna circuit may comprise a set of parallel antenna buses, each antenna bus comprising:
a sub-array of antennas along its length; and
communications circuitry for each of the antennas of the sub-array along the bus.

When the sleeve is mounted around the street light support structure, the different antenna buses will face in different directions, automatically giving wide coverage of the user area.

The antenna circuit may further comprise a connecting bus for connecting the set of parallel antenna buses to a backend processing circuit. There is a backend processing circuit for connection to multiple communications modules via their connecting bus.

The sleeve may comprise a backside metallic screen. This provides shielding to the typically metal material of the street light support structure, e.g. a lamp post.

The communications module may comprise an antenna ground plane which extends fully around the portion of the street light. The sleeve may define a 360 degree ground plane instead of using the material of the street light support structure.

The sleeve is for example adapted to fit to the portion of the street light in a selectable orientation and the module comprises a locking arrangement for locking the sleeve in a selected orientation. This enables the directional characteristics of the antennas to be set and also to be adjusted if desired.

The invention also provides a street light, comprising:
a street light support structure;
a street lighting head mounted at a top of the street light support structure; and
the communications module defined above.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a street at which users carry mobile devices;

FIG. 2 shows two street lights and users as well as vehicles;

FIG. 3 shows a first communications module attached to an upright support (lamp post) of a street light;

FIG. 4 shows that each sleeve may comprise an independent unit for fitting around a street light portion;

FIG. 5 shows a printed foil consisting of eight antenna stripes;

FIG. 6 shows an example of a cylindrical lamp post which comprises an active antenna array;

FIG. 7 shows antenna arrays integrated into the arm bracket which extends above the illumination area;

FIG. 8 shows a sleeve forming a rim to be mounted to the street light luminaire itself;

FIG. 9 shows how a reflective ground plane is formed; and

FIG. 10 shows a sleeve with an adjustment feature.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a communications module comprising a sleeve for extending around a portion of a street light. An antenna circuit is integrated into the sleeve and comprises an array of antennas for implementing communication with user mobile devices in the vicinity of the street light.

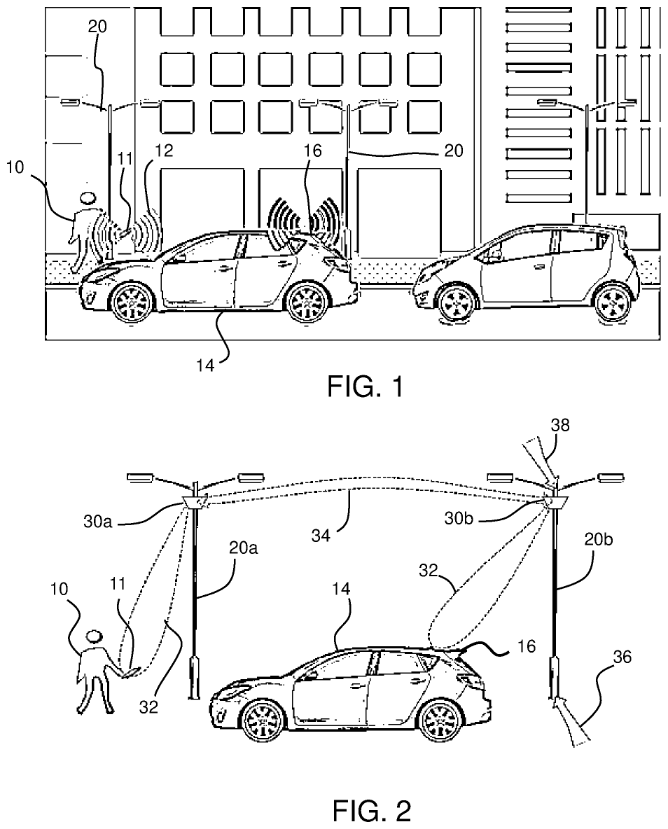

FIG. 1 shows a street at which users 10 carry mobile radio appliances 11, such as mobile phones or tablets, which communicate by means of radio waves 12. Similarly, vehicles 14 are equipped with mobile radio appliances coupled to RF antennas 16.

The communication with the radio appliances is by means of antennas and antenna circuits fitted to street lights 20. The street lights 20 can interconnect with each other as well as with end users.

FIG. 2 shows two street lights 20a, 20b, wherein each street light carries access point 30a, 30b. The user devices 11 or other mobile data stations such as the car communication system and its antenna 16 are connected with the access points 30a, 30b by means of steerable RF beams 32. A meshed connection 34 is provided between the access points 30a, 30b. The information flow to the main data network may either be supported by a wired 36 or a wireless 38 backhaul data connection to the lighting infrastructure.

The invention relates to an active antenna array which is integrated into a sleeve, i.e. curved structure, such as a cylindrical structure which is for surrounding a portion of the street light structure. In particular, the invention provides a communications module for attachment to (or formed as part of) a portion of a street light, such as a support structure (e.g. lamp post) or the lighting head (luminaire) itself.

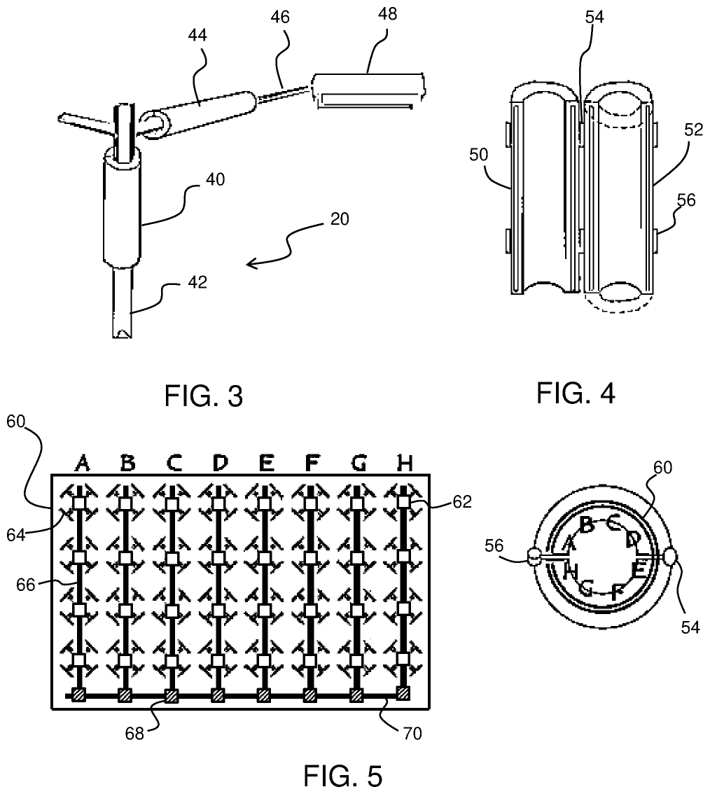

FIG. 3 shows a first communications module 40 attached to an upright support pole of the street light 20, i.e. a lamp post 42, and a second communications module 44 attached to a horizontal support arm 46 leading to the lighting head, i.e. street light luminaire 48.

Each communications module comprises an array of RF antennas and antenna processing circuits.

This enables the existing street light infrastructure to be used to form access points of a network for communicating with user mobile devices, i.e. a communications system for communicating between the mobile devices, which are typically cellular mobile phones or tablets, of users.

The communications circuitry in each module is for example implemented with a large number of antennas each with an associated antenna processing circuit. The overall communications system for example has more antennas than active users.

The communications circuitry of each module in particular comprises antenna processing circuits for a cell-free massive multiple input multiple output, mMIMO, communications system. The antennas thereby form part of a cell-free massive MIMO system, in which a large number of low cost distributed antennas connect to a network controller, and each antenna functions as a separate access point. Different antennas within the module have a different directionality so that in combination they define a service area of the network.

The communications modules 40, 44 may be an integral element of the skin of the lamp post or support arm or they may be part of a sleeve which can be attached to an existing lamp post, or support arm, or luminaire. By providing retrofit (i.e. attachable and removable) units, they may be attached to the existing lighting infrastructure.

The use of a sleeve which fits around a street light support structure means the design is unobtrusive while still allowing for good coverage for the steerable beams. The sleeves can be designed to be an easy fix to a range of potential carriers, for example different support structure elements of a street light. The sleeve can have an unobtrusive form factor which is not easily visible and it can be rugged and weatherproof. When mounted around on a vertical lamp post, it is preferably mounted above the level of the top of the vehicular traffic, to avoid signal blockage as well as reducing the risk of accidental damage.

Providing the communications module on a horizontal support arm 46 means the antenna direction can easily span the street while also giving good directivity from arm to arm on adjacent street lights. Putting the communications model on the vertical post also give good directivity from post to post and also across a street. In combination, as shown in FIG. 3, a broad control of directivity may be achieved.

The sleeves for example comprise a cylindrical structure with a central bore.

FIG. 4 shows that each sleeve may comprise an independent unit for fitting around the street light portion with a first half 50 and a second half 52 which are fixable around the street light portion.

The two halves 50, 52 are for example made from stiff plastic material. The two halves are kept together by means of hinges 54 and a closing snap mechanism 56. The antenna foil is for example mounted in a void formed with the body of each sleeve half.

The antenna arrays may take the form of radio stripes as discussed above.

FIG. 5 shows a printed foil 60 consisting of eight antenna stripes (A-H).

Each antenna stripe consists of a line of active circuits 62 connected to antenna metallization 64 and a bus 66.

The antenna metallization defines a set of four dipole antennas at the location of each active circuit. Each active circuit thus has a set of four modulation and demodulation circuits. Each active circuit is an antenna processing unit, APU, which can drive multiple antennas (i.e. the eight poles of four dipole antennas, hence with four modulator/demodulator circuits and four amplifier circuits). The active circuits 62 each comprise packet switching circuitry, a digital signal processor DSP, I/Q modulators/demodulators and RF amplifiers.

Bus repeaters 68 drive all of the stripes from a single bus 70 which is connected to the backend processing unit of each street light.

The antenna foil is placed in the two halves 50, 52 of the sleeve. The foil is for example manufactured such that one stripe, e.g. Stripe “A” is positioned diametrically opposite to another, e.g. Stripe “E”, when installed, as shown in the right image of FIG. 5.

By controlling all of the antennas as a bended phased array, fine grain beam shaping and positioning in angular as well as axial directions of the sleeve is possible.

The antenna foil 60 may include a backside metallization functioning as an electrical screen for any interference coming from the back. In addition, this guarantees that the antenna sees a controlled impedance at the back rather than any metallic structural elements carrying the sleeve.

The sleeve housing may be produced as two separate parts. An outer shell may be formed with integrated hinges and snap mechanisms, and a separate inner cover may be provided. The antenna foil is then for positioning between the two parts. Both of these parts may be single plastic parts produced in one injection molding process.

The antenna stripes can for example be glued inside the outer shell before fitting the inner cover. Connections may all be made using the same carrier foil which holds the antenna metallization. Alternatively, connectors or contact springs may be used to connect the circuitry between the sleeve housing parts. The antenna foil may be produced as a single piece to fit exactly within the outer shell. An additional space may be provided in the housing for RF backend processing circuitry.

The housing may have spring features, such as spring-biased clamps, spring-biased fasteners, spring-loaded tension belts, or compressible pads inside the bore in order to fit exactly on the carrier. Thus, a spring bias arrangement may be used to enable the sleeve to fit to a range of sizes of street light portion.

The sleeve halves may additionally or alternatively be held in place by means of bands extending around the outer shell. In order to not influence the RF signal these band would be made from a non-conductive material.

The antenna foil may instead be glued directly onto the underlying structural support e.g. lamp post. A heat shrinkable tube may instead allow the sleeve to be shrunk around an underlying support.

The sleeve housing may have locking features such as protrusions and/or notches which fit into corresponding locking features (notches and/or protrusions) in the portion of the street light. The street light portions may instead have a non-circular cross section so that the fitting of the sleeve housing can only be made in one angular orientation. If the street light portion is curved instead of straight, this will also mean that a correspondingly shape sleeve housing will only fit with one particular angular orientation. Thus, there are various different ways to ensure a desired angular orientation.

This ensures a fixed direction of mounting. In this way, the antennas may for example be positioned to radiate optimally in a direction to enable mesh connections to neighboring posts or to posts on the opposite side of the road.

For example, with reference to FIG. 5, this may ensure that antenna stripes A and E are optimally directed towards neighboring posts (for a straight road) and antenna stripe C is directed towards the other road side. This may ease commissioning of the network.

The sleeve housing may be locked in place with screws or bolts. These may in addition serve as electrical contacts to feed power into the sleeve. The receptacles for these bolts or screws in the post may be covered by a sealing cap or paint which can be pierced by the insertion of the bolt or screw. This means the street light is prepared for the mounting of a communications module sleeve, while keeping electrical and mechanical connection parts isolated from the environment.

The sleeve may instead have a rotary adjustment system so that a fixed part of the rotary adjustment system fits to the street light and the antenna foil connects to an adjustable part.

In both of these examples, the sleeve can fit to the portion of the street light in a selectable orientation and the module comprises a locking arrangement for locking the sleeve is a selected orientation.

In the examples above, the communications module may be applied as a retrofit system to an existing lighting infrastructure.

The communications module may instead be an integral element of a portion of a street light (such as the lamp post or other support arm), or it may be a modular component such as a modular arm or bracket. The communications module may even be embedded into a finishing layer or skin which is applied to the lamp post surface during production.

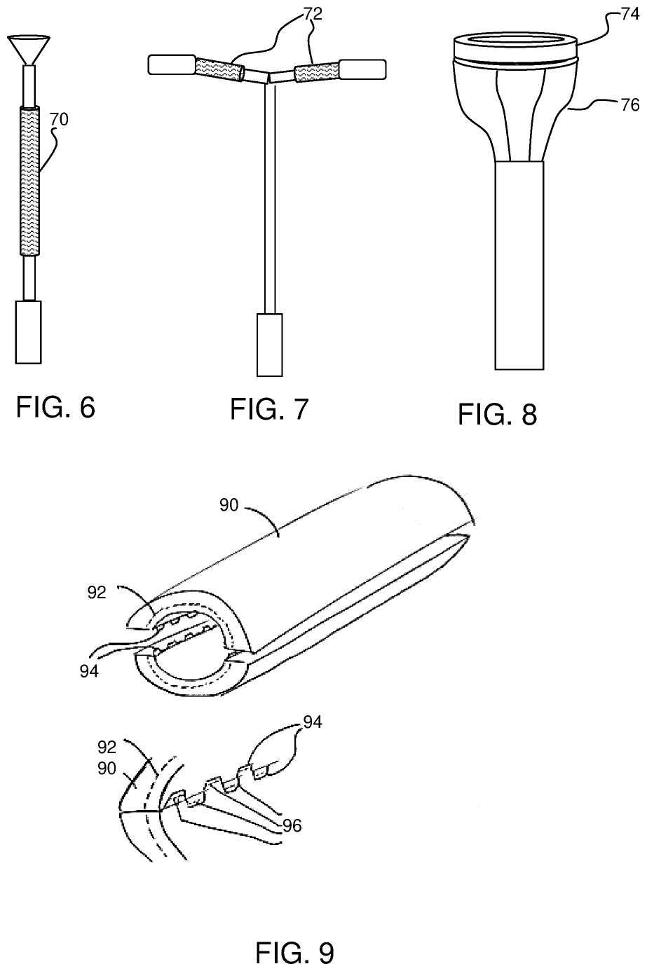

FIG. 6 shows an example of a cylindrical lamp post which comprises an active antenna array 70 which enables RF communication in all directions around the lamp post.

FIG. 7 shows antenna arrays integrated into the arm bracket which extends above the illumination area. The arms are positioned substantially horizontally above the street which is beneficial to provide a good RF communication signal towards road users (e.g. mobile or wearable devices, smart vehicles etc.).

The designs of FIGS. 6 and 7 may thus be part of the design of the post or arm rather than a retrofit solution.

FIG. 8 shows a sleeve 74 forming a rim to be mounted to the street light luminaire 76 itself. It may be fitted to a circular or cylindrical streetlight luminaire and may fit around the luminous surface and thereby surround a circular light source of the street light.

The lamp post is typically an electrically conducting material such as iron, meaning that reflections take place as soon as the antenna structure is placed next to it. This is a problem for normal operation due to the resulting shielding and cancelling of signals, in particular if the distance between the lamp post and the antenna is not optimal.

The exact distance between the lamp post (or other supporting structure) and the antenna structure is critical for the performance of the propagation of electromagnetic fields towards the client devices.

One approach, as mentioned above, is to provide a conducting foil at the back behind the antenna layer, behaving as a reflective ground plane. In this case, the distance between the conductor and the antenna structure, and the choice of isolation material, can provide for an optimal reflector behavior.

The antenna foil begins and ends at the edges of the sleeve (where the sleeve opens and closes). These ends are preferably connected to form a closed plane as shown in FIG. 9.

In FIG. 9, the sleeve 90 incorporate the antenna layer 92 internally as explained above and the inner side of the sleeve acts as a conductive ground plane. Fingers 94 at the inner side of the sleeve are used to create pressure and contact on each surface 96 of the inner side of the sleeve to create a 360-degree conducting reflective ground plane for the antenna structures in the antenna 92.

Another approach is to have the antenna layer over the post (or other supporting structure) without a conducting foil. In this case, the conducting lamp post behaves as a conducting electromagnetic reflective surface. When there is no conductive layer, the lamp post acts as reflecting conductor plane, but it is desirable to have an optimum distance between the post and the antenna.

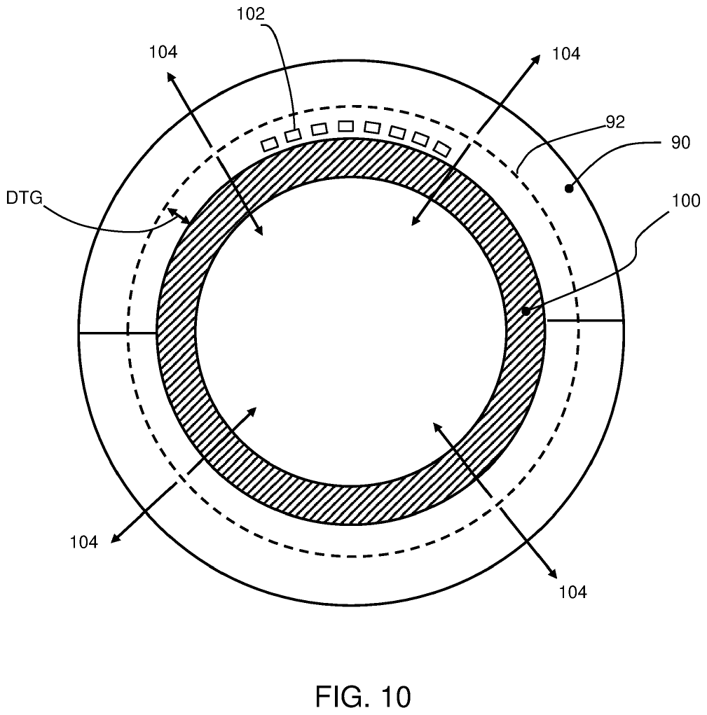

FIG. 10 shows that the sleeve 90 is mounted around a post 100 acting as ground plane. Small elements, for example piezo elements 102, may be incorporated in the sleeve 90 which can be activated by a low power electrical voltage to adjust the distance between the antenna layer 92 and the post 100, e.g. to push the antenna layer 92 in a radial direction which makes the distance (DTG, distance to ground) increase in all directions (shown by arrows 104) or to fine tune the spacing as a function of direction around the post. This distance could vary because of paint or dirt, or it may be desired because different frequencies may be applied at different locations.

The position adjustment may for example be used to provide directional sensitivity. For this purpose, the post may be equipped with a gear or profiled surface. Adjusting the distance to such a surface will change the antenna properties and direction sensitivity.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”.

Any reference signs in the claims should not be construed as limiting the scope.

1. A communications module comprising:
a sleeve for extending around a portion of a street light or for being an integral part of said portion, wherein the sleeve comprises an inner cover and an outer shell;
an antenna foil comprising an antenna circuit and comprising an array of antennas; and
communications circuitry electrically connected to the antennas,
a respective antenna processing circuit for each of the antennas, for implementing communication with user mobile devices in the vicinity of the street light, and
wherein the antenna foil is positioned between the inner cover and the outer shell of the sleeve.

2. The communications module of claim 1, wherein the communications circuitry comprises antenna processing circuits for a cell-free massive multiple input multiple output (CF mMIMO) communications system.

3. The communications module of claim 1, wherein the portion of a street light comprises a street light support structure or a street light luminaire.

4. The communications module of claim 1, wherein the antennas of the array are spaced around the sleeve thereby to be spaced around the street light portion.

5. The communications module of claim 1, comprising an independent unit for fitting around the street light portion.

6. The communications module of claim 5, wherein the sleeve comprises first and second sleeve halves which are fixable around the street light portion.

7. The communications module of claim 5, wherein:
the communications module comprises a spring bias arrangement to enable the sleeve to fit to a range of sizes of street light portion.

8. The communications module of claim 5, comprising an adjustable spacing element for adjusting a spacing between the antenna and the street light portion.

9. The communications module of claim 1, wherein the sleeve is flexible and is for gluing to the street light portion.

10. The communications module of claim 1, wherein the antenna circuit comprises a set of parallel antenna buses, each antenna bus comprising:
a sub-array of antennas along its length; and
communications circuitry for each of the antennas of the sub-array along the bus.

11. The communications module claim 10, wherein the antenna circuit further comprises a connecting bus for connecting the set of parallel antenna buses to a backend processing circuit.

12. The communications module of claim 1, wherein the sleeve comprises a backside metallic screen.

13. The communications module of claim 1, comprising an antenna ground plane which extends fully around the portion of the street light.

14. The communication module of claim 1, wherein the sleeve is adapted to fit to the portion of the street light in a selectable orientation and the module comprises a locking arrangement for locking the sleeve is a selected orientation.

15. A street light, comprising:
a street light support structure;
a street lighting head mounted at a top of the street light support structure; and
the communications module of claim 1.
